(19) United States
(12) Patent Application Publication
(10) Pub. No.: US 2013/0151225 A1
(43) Pub. Date: Jun. 13, 2013

(54) AUTOMATED VERIFICATION FLOW

(71) Applicant: Venkata Krishnan Kidambi Srinivasan, Tucson, AZ (US)

(72) Inventor: Venkata Krishnan Kidambi Srinivasan, Tucson, AZ (US)

(73) Assignee: Texas Instruments Incorporated, Dallas, TX (US)

(21) Appl. No.: 13/324,686

(22) Filed: Dec. 13, 2011

(51) Int. Cl. G06F 17/50

(52) U.S. Cl. 703/14

(57) ABSTRACT

A method for verifying a circuit is provided. A first portion of a simulation of the circuit is executed within a hardware description language (HDL) environment so as to generate a first data set. A tool (which is external to the HDL environment) is called using a system task within the HDL environment. The tool is then executed on the first data set to generate a second data set, and a second portion of the simulation of the circuit is executed within the HDL environment using the second data set.

### TECHNICAL FIELD

The invention relates generally to computer program and, more particularly, to computer program in a circuit simulation environment.

### BACKGROUND

Most verification engineers can be faced problems with designs that involve computing the Fast Frequency Transforms (FFTs) of output data to verify if the design is operating correctly. In the typical Verilog environment (such as Verilog-2005 (as set forth in Institute for Electrical and Electronics Engineers (IEEE) Standard 1364-2005, which is dated Apr. 7, 2006 and which is incorporated by reference herein) and SystemVerilog (as set forth in IEEE Standard 1800-2009, which is dated Dec. 11, 2009 and which is incorporated by reference herein), computing these FFTs cannot be done in an automated way, as there is no known way to incorporate it into an already existing testbench frameworks for typical Verilog environments. Traditionally, this verification has been accomplished by “dumping” certain values to a file and using an alternate environment (such as MATLAB®) to verify these “points” manually, which can be tedious and time consuming, especially if there are many combinations to verify. Therefore, there is a need for an improved verification method and/or algorithm.

### SUMMARY

An embodiment of the present invention, accordingly, provides a processor with a memory having a computer program embodied thereon. The computer program comprises computer code for executing a first portion of a simulation of a circuit within a hardware description language (HDL) environment so as to generate a first data set; computer code for calling a tool using a system task within the HDL environment, wherein the tool is external to the HDL environment; computer code for executing the tool on the first data set to generate a second data set; and computer code for executing a second portion of the simulation of the circuit within the HDL environment using the second data set.

In accordance with an embodiment of the present invention, the computer code for executing the first portion of the simulation further comprises computer code for writing the first data set to a file.

In accordance with an embodiment of the present invention, the file further comprises a first file, and wherein the computer program for executing the tool further comprises: computer code for reading the first data set from the first file; and computer code for writing the second data set to a second file.

In accordance with an embodiment of the present invention, the computer code for executing the second portion of the simulation further comprises computer code for reading the second data set from the second file.

In accordance with an embodiment of the present invention, the HDL is a Verilog environment.

In accordance with an embodiment of the present invention, the system task further is $system.

In accordance with an embodiment of the present invention, the tool implements a Fast Fourier Transform (FFT).

In accordance with an embodiment of the present invention, a method is provided. The method comprises executing a first portion of a simulation of a circuit within a HDL environment so as to generate a first data set; calling a tool using a system task within the HDL environment, wherein the tool is external to the HDL environment; executing the tool on the first data set to generate a second data set; and executing a second portion of the simulation of the circuit within the HDL environment using the second data set.

In accordance with an embodiment of the present invention, the step of executing the first portion of the simulation further comprises writing the first data set to a file.

In accordance with an embodiment of the present invention, the file further comprises a first file, and wherein the step of executing the tool further comprises: reading the first data set from the first file; and writing the second data set to a second file.

In accordance with an embodiment of the present invention, the step of executing the second portion of the simulation further comprises reading the second data set from the second file.

In accordance with an embodiment of the present invention, a computer program that is configured to be executed in a data processing system is provided. The computer program comprises a simulator that operates in a Verilog environment, wherein the simulator is configured to generate a first data set that corresponds to a first portion of a simulation of a circuit, and wherein the simulator is configured to write the first data set to a first file; and a tool that operates in an alternate environment, wherein the tool is configured to be called by the simulator using a system task within the Verilog environment after the first data set is written to the first file, and wherein the tool is configured to generates a second data set from the first data set, and wherein the tool is configured to write the second data set to a second file.

In accordance with an embodiment of the present invention, the simulator further comprises: an engine; and a plurality of modules that are each configured to be called by the engine to perform at least one of a plurality of tasks.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of an example of a computer network;

FIG. 2 is a diagram of an example of a system that employs a circuit simulator in accordance with the present invention; and

FIG. 3 is an example flowchart depicting the operation of the system of FIG. 2.

### DETAILED DESCRIPTION

Refer now to the drawings wherein depicted elements are, for the sake of clarity, not necessarily shown to scale and wherein like or similar elements are designated by the same reference numeral through the several views.

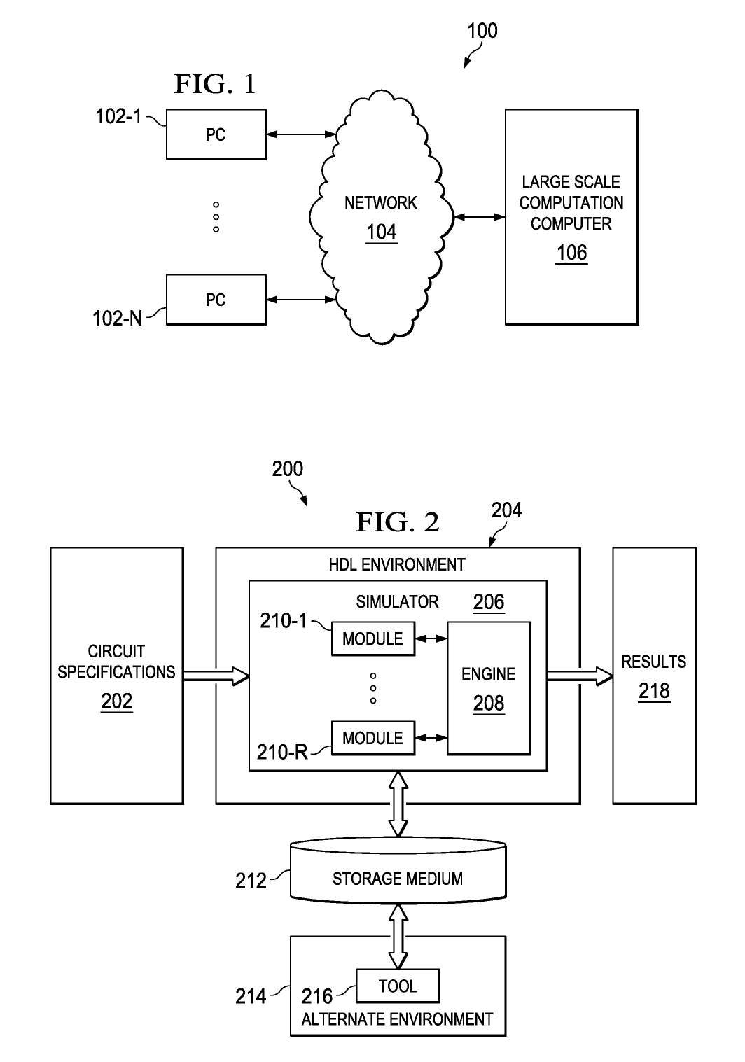

Turning to FIG. 1, the reference numeral 100 generally designates a computer network. Network 100 generally comprises personal computers (PCs) or terminals 102-1 to 102-N, a packet switching network 104, and a large scale computation computer 106. Each of these computers 102-1 to 102-N and 106 includes one or more processors and a storage medium (such as random access memories and hard disk drives), where the processor can execute computer program code or software instructions which are stored in the storage media. Circuit simulators (which are generally computer code or software instructions) generally take many forms and which can operate or be executed on one or more of the PCs 102-1 to 102-N or over the network 104 (where computer 206 performs at least a portion of the computations).

In FIG. 2, a system 200 is shown, which generates simulation results 218 from circuit specifications 202. In order to accomplish this, the system 200 employs simulator 206 that operates in a hardware description language (HDL) environment 204, such as the Verilog environment set forth above. The simulator 206 comprises an engine 208 that interacts with a modules 210-1 to 210-R (which can, for example, include matrix solvers) to generate data sets that can be stored in storage medium 212. In addition to the simulator 206, which operates in the HDL environment 204, there is also a tool 216, which operates in an alternate environment (such as MATLAB®), that is capable of being automatically called from the HDL environment 204 to execute certain tasks (such as FFTs). Additionally, this system 200 can be implemented on one or more PCs 102-1 to 102-N or distributed in some manner across network 100.

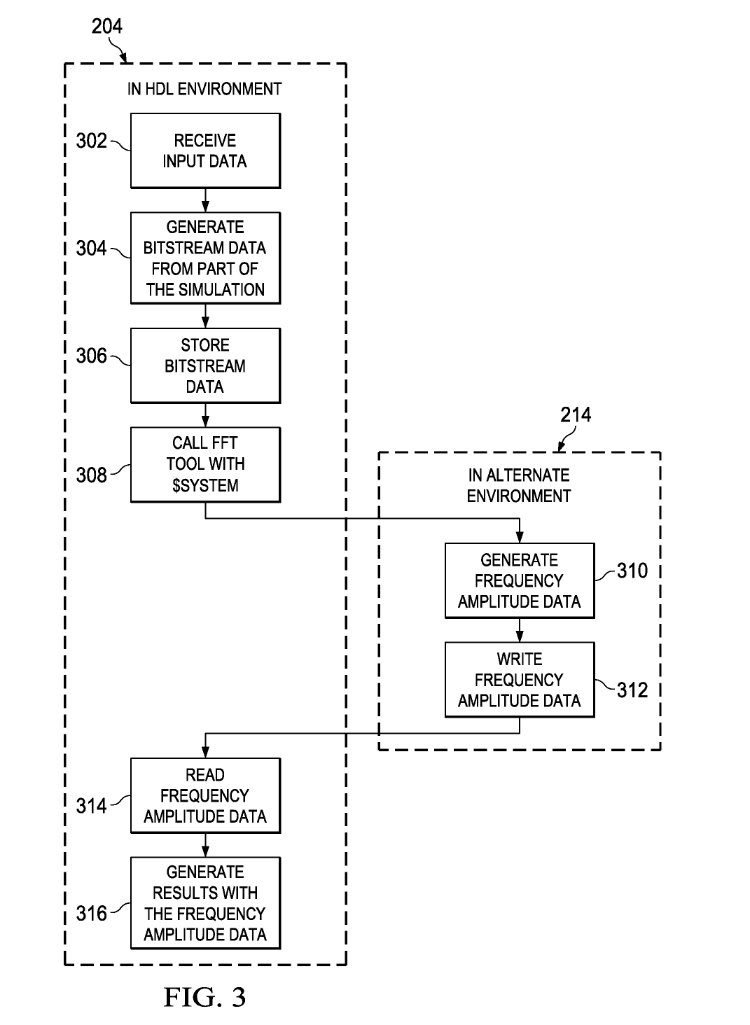

To illustrate the operation of system 200, an example is provided in FIG. 3. In this example, input data (i.e., circuit specifications 202) are received by the simulator 206 in the HDL environment 204 (which for this example is a Verilog environment as set forth above) in step 302. Based on this input data, bitstream data (or a data set) is generated from part of the execution of the simulator 206 and stored in storage medium 212 (i.e., as part of a file) in steps 304 and 306. Then, the simulator 206 can call tool 216 (in the alternate environment 214) in step 308. Within the Verilog environment (as set forth above), there exists a system task called “$system,” which is an ill-defined routine that allows for this type of execution. For this example, the “$system” system task is used to call a tool that implements an FFT (or an “FFT tool”). An example of an FFT tool (which is entitled “wmath”) is as follows:

wmath dout_win.txt −1 −expr \

‘fft_num=2\hat{ }20,
mod_rate=256000,
for(x[ ] ;wy[_i]=_*y[_i]),
b [ ] = f ft (wy [ ] ) ,
for (b [ ];_=_*_),
c [ ]=b [ ],
for(c[ ];if((_i)%2==1;spec[++i]=b[ i]+b[ i+1])),
spec[O]=b[O] ,
peak_ind=max(spec[O .. (fft_num/64)]),
peak_ind_wa=peak_ind+((spec[peak_ind+1]−
spec[peak_ind−1])/(2*spec[peak_ind])),
freq_input=(peak_ind)/fft_num*mod_rate’ \
−print freq_input > dout fft.txt

Using this tool 216 (in this example), frequency amplitude data can be generated and stored (as a data set and as part of a file) in steps 310 and 312 in alternate environment 214. The simulator 206 can then read out the frequency amplitude data in step 314 and generate the results 218 in step 316. Additionally, steps 302 to 316 can be repeated any number of times in order to verify multiple device configurations, allowing for full automation of the verification of a device or circuit corresponding to the circuit specifications 202 and allowing for real-time results.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Accordingly, it is appropriate that the appended claims be construed broadly and in a manner consistent with the scope of the invention.

1. A processor with a memory having a computer program embodied thereon, the computer program comprising:
computer code for executing a first portion of a simulation of a circuit within a hardware description language (HDL) environment so as to generate a first data set;
computer code for calling a tool using a system task within the HDL environment, wherein the tool is external to the HDL environment;
computer code for executing the tool on the first data set to generate a second data set; and
computer code for executing a second portion of the simulation of the circuit within the HDL environment using the second data set.

2. The computer program of claim 1, wherein the computer code for executing the first portion of the simulation further comprises computer code for writing the first data set to a file.

3. The computer program of claim 2, wherein the file further comprises a first file, and wherein the computer program for executing the tool further comprises:
computer code for reading the first data set from the first file; and
computer code for writing the second data set to a second file.

4. The computer program of claim 3, wherein the computer code for executing the second portion of the simulation further comprises computer code for reading the second data set from the second file.

5. The computer program of claim 4, wherein the HDL is a Verilog environment.

6. The computer program of claim 5, wherein the system task further is $system.

7. The computer program of claim 6, wherein the tool implements a Fast Fourier Transform (FFT).

8. A method comprising:
executing a first portion of a simulation of a circuit within a HDL environment so as to generate a first data set;
calling a tool using a system task within the HDL environment, wherein the tool is external to the HDL environment;
executing the tool on the first data set to generate a second data set; and
executing a second portion of the simulation of the circuit within the HDL environment using the second data set.

9. The method of claim 8, wherein the step of executing the first portion of the simulation further comprises writing the first data set to a file.

10. The method of claim 9, wherein the file further comprises a first file, and wherein the step of executing the tool further comprises:
reading the first data set from the first file; and
writing the second data set to a second file.

11. The method of claim 10, wherein the step of executing the second portion of the simulation further comprises reading the second data set from the second file.

12. The method of claim 11, wherein the HDL is a Verilog environment.

13. The method of claim 12, wherein the system task further is $system.

14. The method of claim 13, wherein the tool implements an FFT.

15. A computer program that is configured to be executed in a data processing system, the computer program comprising:
a simulator that operates in a Verilog environment, wherein the simulator is configured to generate a first data set that corresponds to a first portion of a simulation of a circuit, and wherein the simulator is configured to write the first data set to a first file; and
a tool that operates in an alternate environment, wherein the tool is configured to be called by the simulator using a system task within the Verilog environment after the first data set is written to the first file, and wherein the tool is configured to generates a second data set from the first data set, and wherein the tool is configured to write the second data set to a second file.

16. The method of claim 15, wherein the system task further is $system.

17. The method of claim 16, wherein the tool implements an FFT.

18. The method of claim 17, wherein the simulator further comprises:
an engine; and
a plurality of modules that are each configured to be called by the engine to perform at least one of a plurality of tasks.
